(19) United States
(12) Patent Application Publication
(10) Pub. No.: US 2026/0161031 A1
(43) Pub. Date: Jun. 11, 2026

(54) MULTILAYER LIQUID CRYSTAL LENS

(71) Applicant: KOREA ELECTRONICS TECHNOLOGY INSTITUTE, Seongnam-si (KR)

(72) Inventor: Soon Hyung KWON, Seongnam-si (KR)

(73) Assignee: KOREA ELECTRONICS TECHNOLOGY INSTITUTE, Seongnam-si (KR)

(21) Appl. No.: 19/411,642

(22) Filed: Dec. 8, 2025

(30) Foreign Application Priority Data
Dec. 9, 2024 (KR) 10-2024-0181808

(51) Int. Cl. G02F 1/1347; G02F 1/1333; G02F 1/1339

(52) U.S. Cl. CPC G02F 1/13471; G02F 1/133377; G02F 1/1339

(57) ABSTRACT

A multilayer liquid crystal lens is disclosed. The multilayer liquid crystal lens includes a lens having one surface and another surface opposite to the one surface, and a plurality of liquid crystal layers formed on the one surface or the opposite surface of the lens. The plurality of liquid crystal layers refracts a part of light advancing from the opposite surface to the one surface in accordance with an alignment direction of liquid crystals in the plurality of liquid crystal layers and converges the refracted light part toward a center or diverges the refracted light part from the center in accordance with a convex or concave shape of the one surface or the opposite surface of the lens.

### CROSS REFERENCE TO RELATED APPLICATION

The present application claims priority to Korean Patent Application No. 10-2024-0181808, filed Dec. 9, 2024, the entire contents of which is incorporated herein for all purposes by this reference.

### TECHNICAL FIELD

The present disclosure relates to a multilayer liquid crystal lens.

### BACKGROUND

Eyeglasses are used to correct vision. Myopia is a condition in which distant objects appear blurry. Hyperopia is a condition in which nearby objects appear blurry. Generally, convex-lens glasses are used to correct hyperopia, and concave-lens glasses are used to correct myopia. Hyperopia occurs due to aging of the eyes, and even people with myopia may develop hyperopia as they age.

A typical vision-correction lens is a single-focus lens. The single-focus lens has one focus and may correct only one of myopia and hyperopia. Bifocal or multifocal lenses have regions within one lens with different refractive powers, allowing vision correction for near or far distances depending on the gaze direction of the wearer. However, these lenses may cause dizziness when changing the gaze direction, and there are aesthetic issues at the boundary between the near and far zones.

### SUMMARY

An aspect of the present disclosure is to provide a multilayer liquid crystal lens having multiple focuses through formation of a plurality of liquid crystal layers in the lens.

In accordance with an aspect of the present disclosure, a multilayer liquid crystal lens includes a lens having one surface and another surface opposite to the one surface, and a plurality of liquid crystal layers formed on the one surface or the opposite surface of the lens, wherein the plurality of liquid crystal layers refracts a part of light advancing from the opposite surface to the one surface in accordance with an alignment direction of liquid crystals in the plurality of liquid crystal layers and converges the refracted light part toward a center of the lens or diverges the refracted light part from the center in accordance with a convex or concave shape of the one surface or the opposite surface of the lens.

In accordance with an embodiment, the lens may be a convex lens, and the plurality of liquid crystal layers may be formed on the one surface of the lens to refract a part of the light advancing from the opposite surface to the one surface and to diverge the refracted light part from the center.

In accordance with an embodiment, the lens may be a convex lens, and the plurality of liquid crystal layers may be formed on the opposite surface of the lens to refract a part of the light advancing from the opposite surface to the one surface and to converge the refracted light part toward the center.

In accordance with an embodiment, the lens may be a concave lens, and the plurality of liquid crystal layers may be formed on the one surface to refract a part of the light advancing from the opposite surface to the one surface and to converge the refracted light part toward the center.

In accordance with an embodiment, the lens may be a concave lens, and the plurality of liquid crystal layers may be formed on the opposite surface to refract a part of the light advancing from the opposite surface to the one surface and to diverge the refracted light part from the center.

In accordance with an embodiment, the plurality of liquid crystal layers may be formed by stacking two or more liquid crystal layers in a predetermined direction.

In accordance with an embodiment, in the plurality of liquid crystal layers, alignment directions of liquid crystals in respective liquid crystal layers may be identical.

In accordance with an embodiment, each of the plurality of liquid crystal layers may have an alignment direction of liquid crystals rotated unidirectionally about the center of the lens, and rotation angles of the liquid crystals in respective liquid crystal layers may be different.

In accordance with an embodiment, the plurality of liquid crystal layers may include a plurality of liquid crystal layers having the same alignment direction of liquid crystals and a plurality of liquid crystal layers respectively having different alignment directions of liquid crystals.

In accordance with an embodiment, the multilayer liquid crystal lens may further include a plurality of alignment layers configured to align liquid crystals in predetermined directions for the plurality of liquid crystal layers, respectively.

In accordance with an embodiment, the plurality of liquid crystal layers and the plurality of alignment layers may be alternately laminated.

In accordance with an embodiment, the multilayer liquid crystal lens may further include a protective layer coupled to the plurality of liquid crystal layers.

In accordance with an embodiment, each of the liquid crystal layers may include liquid crystals configured to refract a part of light in accordance with an alignment direction thereof, and a binder configured to fix the liquid crystals in the predetermined alignment direction.

In accordance with an embodiment, the liquid crystal layer may further include a plurality of capsules configured to contain the liquid crystals and the binder therein.

In accordance with an embodiment, the plurality of capsules may be formed as a layer on the one surface of the lens.

In accordance with an embodiment, the multilayer liquid crystal lens may further include an adhesive layer configured to bond one of the liquid crystal layers to the lens or another one of the liquid crystal layers.

Prior to the description, it should be understood that the terms used in the specification and appended claims should not be construed as limited to general and dictionary meanings, but interpreted based on the meanings and concepts corresponding to technical aspects of the present disclosure on the basis of the principle that the inventor is allowed to define terms appropriately for best explanation.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a view showing a multilayer liquid crystal lens according to an embodiment;

FIG. 2 is a view showing an alignment of liquid crystals in liquid crystal layers according to an embodiment.

FIG. 3 is a view showing a multilayer liquid crystal lens in which a liquid crystal layer is formed on one surface of a convex lens in accordance with an embodiment;

FIG. 4 is a view showing a multilayer liquid crystal lens in which a liquid crystal layer is formed on an opposite surface of a convex lens in accordance with an embodiment;

FIG. 5 is a view showing a multilayer liquid crystal lens in which a liquid crystal layer is formed on one surface of a concave lens in accordance with an embodiment;

FIG. 6 is a view showing a multilayer liquid crystal lens in which a liquid crystal layer is formed on an opposite surface of a concave lens in accordance with an embodiment;

FIG. 7 is a view showing a plurality of liquid crystal layers having the same alignment direction of liquid crystals in accordance with an embodiment;

FIG. 8 is a view showing respective alignment directions of liquid crystals in a plurality of liquid crystal layers of FIG. 6;

FIG. 9 is a diagram showing a variation in focal length according to the number of liquid crystal layers having the same alignment direction of liquid crystals in accordance with an embodiment;

FIG. 10 is a view showing a plurality of liquid crystal layers having different alignment directions of liquid crystals in accordance with an embodiment;

FIG. 11 is a diagram showing alignment directions of liquid crystals in respective liquid crystal layers of FIG. 10;

FIG. 12 is a diagram showing focuses of a plurality of liquid crystal layers having different alignment directions of liquid crystals in accordance with the embodiment;

FIG. 13 is a view showing a plurality of liquid crystal layers having the same alignment direction of liquid crystals and a plurality of liquid crystal layers having different alignment directions of liquid crystals in accordance with an embodiment;

FIG. 14 is a diagram showing alignment directions of liquid crystals in the plurality of liquid crystal layers of FIG. 13;

FIG. 15 is a diagram showing focuses according to the plurality of liquid crystal layers having different alignment directions of liquid crystals and focuses according to the plurality of liquid crystal layers having the same alignment direction of liquid crystals in the shown embodiment;

FIG. 16 is a view showing a multilayer liquid crystal lens further including a plurality of alignment layers and a protective layer in accordance with an embodiment;

FIG. 17 is a view showing a plurality of liquid crystal layers including capsules according to an embodiment;

FIG. 18 is a view showing a multilayer liquid crystal lens further including an adhesive layer in accordance with an embodiment; and

FIG. 19 is a view showing a multilayer liquid crystal lens further including an alignment layer, a protective layer, and an adhesive layer in accordance with an embodiment.

### DETAILED DESCRIPTION

Hereinafter, with reference to the attached drawings, the present disclosure will be described in detail. However, this is only illustrative and the present disclosure is not limited to specific embodiments illustratively described herein.

Hereinafter, embodiments of the present disclosure will be described in detail with reference to the accompanying drawings.

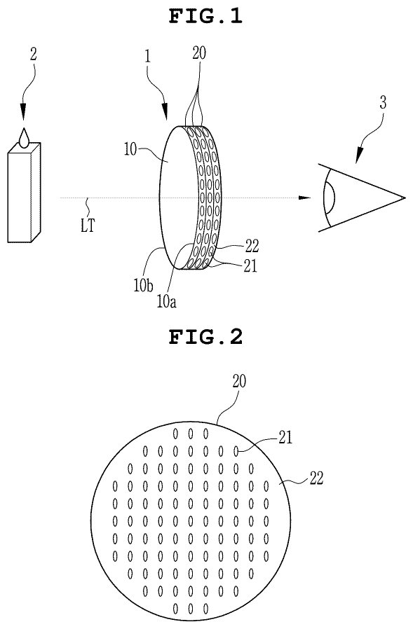

FIG. 1 is a view showing a multilayer liquid crystal lens 1 according to an embodiment. FIG. 2 is a view showing an alignment of liquid crystals 21 in liquid crystal layers 20 according to an embodiment.

The multilayer liquid crystal lens 1 may include a lens 10 having one surface 10a facing an observer 3 and another surface 10b opposite to the surface 10a and facing an object 2, and a plurality of liquid crystal layers 20 formed on the surface 10a or the opposite surface 10b of the lens 10. The plurality of liquid crystal layers 20 may refract a part of light advancing from the opposite surface 10b to the surface 10a in accordance with an alignment direction of the liquid crystals 21 and may converge the refracted light part toward a center M of the lens 10 or may diverge the refracted light part from the center M in accordance with a convex or concave shape of the surface 10a or the opposite surface 10b of the lens 10.

The multilayer liquid crystal lens 1 has a structure in which the plurality of liquid crystal layers 20 is coupled to the surface 10a or the opposite surface 10b of the lens 10. The multilayer liquid crystal lens 1 may be positioned on a path along which light reflected from the object 2 reaches the observer 3. The following description will be given with reference to the case in which the surface 10a of the lens 10 faces the observer 3, and the opposite surface 10b faces the object 2. The plurality of liquid crystal layers 20 may refract a part of the light advancing from the opposite surface 10b toward the surface 10a and allow another part of the light to pass through the lens 10 without refraction. The light refracted by the plurality of liquid crystal layers 20 may be converged or diverged in accordance with the shape of the surface 10a or the opposite surface 10b of the lens 10 to which the plurality of liquid crystal layers 20 is coupled. The light not refracted by the plurality of liquid crystal layers 20 may be diverged or converged in accordance with the type of the lens 10.

The plurality of liquid crystal layers 20 may include liquid crystals 21 configured to refract light in accordance with an alignment direction thereof. The plurality of liquid crystals 21 included in the liquid crystal layers 20 may be aligned in a predetermined direction. In accordance with the alignment of the liquid crystals 21, a part of light passing through the liquid crystal layer 20 may be refracted and a remaining part of the light may not be refracted. For example, in accordance with an alignment direction of the liquid crystals 21, light polarized in a first direction may be refracted and light polarized in a second direction may not be refracted. Here, polarized light may be linearly polarized light or elliptically (circularly) polarized light. In other words, light oscillating in a first direction may be refracted by the liquid crystals 21, whereas light oscillating in a second direction may not be refracted by the liquid crystals 21. The liquid crystals 21 may refract a part of the light that has passed through the lens 10, in accordance with the alignment direction thereof. Another part of the light that has passed through the lens 10 may not be refracted depending on the alignment direction of the liquid crystals 21.

The plurality of liquid crystal layers 20 differs from a typical polarizer film. The polarizer film transmits a part of polarized light and blocks a remaining part of the polarized light. The liquid crystal layers 20 may completely transmit light incident upon the lens 10. The liquid crystals 21 transmit a part of the light after refracting the light part, and transmit the remaining part of the light without refraction.

Each liquid crystal layer 20 may include liquid crystals 21 configured to refract a part of light in accordance with an alignment direction thereof, and a binder 22 configured to fix the liquid crystals 21 in a predetermined alignment direction. The binder 22 may include a reactive mesogen (RM) material. The reactive mesogen material may be cured when irradiated with ultraviolet light or heated. The liquid crystal layer 20 may be manufactured by applying a mixture of the reactive mesogen material and the liquid crystals 21 to the surface 10a of the lens 10, aligning the liquid crystals 21 in a predetermined alignment direction by applying a magnetic field to the liquid crystals 21, and then curing the reactive mesogen material with ultraviolet light, etc. under the condition that the alignment of the liquid crystals 21 is maintained. Once the reactive mesogen material is cured, the liquid crystals 21 may be fixed in accordance with the predetermined alignment thereof.

The liquid crystals 21 may be aligned in a single direction. In FIGS. 1 and 2, the liquid crystals 21 are aligned in a predetermined direction. The predetermined direction means that the long axis of the liquid crystals 21 is aligned to be parallel to the surface 10a of the liquid crystal layer 20, and the plurality of liquid crystals 21 is aligned in parallel. Referring to FIG. 2, which shows the liquid crystal layer 20 from the front, it can be seen that the long axes of the liquid crystals 21 are aligned in parallel. Referring to FIG. 1, which shows the liquid crystal layer 20 from the side, it can be seen that the long axes of the liquid crystals 21 are aligned to be parallel to the surface 10a of the liquid crystal layer 20. Since the liquid crystal layer 20 has the same curvature as the surface 10a of the lens 10, it can be seen that the plurality of liquid crystals 21 is aligned to have the same curvature as the surface 10a of the lens 10, when the liquid crystal layer 20 is viewed from the side.

Although the alignment direction of the liquid crystals 21 is shown in FIGS. 1 and 2, the alignment direction of the liquid crystals 21 may be different from the shown alignment direction so long as the long axes of the liquid crystals 21 are oriented in a specific direction. For example, the liquid crystals 21 may be aligned such that the long axes thereof are perpendicular to the surface 10a of the lens 10. Alternatively, the liquid crystals 21 may be aligned such that the long axes thereof are inclined at a predetermined angle with respect to the surface 10a of the lens 10. Under the condition that the liquid crystals 21 in the liquid crystal layer 20 are aligned in a predetermined direction, the liquid crystals 21 may refract a part of light incident upon the liquid crystal layer 20 in accordance with the alignment direction thereof and may allow the remaining part of the incident light to pass through the liquid crystal layer 20. In this case, accordingly, it may be possible to converge a part of light and to transmit the remaining part of light, as described above.

The liquid crystal layer 20 may be formed on the surface 10a or the opposite surface 10b of the lens 10 to have a uniform thickness. Since the liquid crystal layer 20 is formed on the surface 10a or the opposite surface 10b of the lens 10, the liquid crystal layer 20 may be formed to have the same curvature as the surface 10a or the opposite surface 10b. Since the liquid crystal layer 20 is formed along the surface 10a or the opposite surface 10b of the lens 10, the liquid crystal layer 20 is curved. The liquid crystal layer 20 may refract a part of the light incident upon the lens 10. By the liquid crystal layer 20, the light refracted along the curve of the surface 10a or the opposite surface 10b of the lens 10 may be converged toward the center M of the lens 10 or may be diverged from the center M of the lens 10. In other words, since the liquid crystal layer 20 is curved to have a predetermined curvature, the liquid crystal layer 20 may converge a part of the light refracted by the liquid crystals 21 toward the center M of the lens 10 or may diverge the light part from the center M.

Since the liquid crystal layer 20 is formed on the surface 10a or the opposite surface 10b of the lens 10, the liquid crystal layer 20 may be formed to have the same curvature as the surface 10a or the opposite surface 10b. When the curvature of the surface 10a or the opposite surface 10b of the lens 10 is great, the liquid crystal layer 20 may converge or diverge an increased quantity of light. That is, the greater the curvature of the surface 10a or the opposite surface 10b of the lens 10, the greater the refractive power of the liquid crystal layer 20. The refractive power of the liquid crystal layer 20 may be applied to a part of light refracted by the liquid crystals 21. Since a part of light not refracted in the liquid crystal layer 20 is transmitted without refraction, this light part may not be converged to or diverged from the center M of the lens 10.

The multilayer liquid crystal lens 1 may have a focus of the lens 10 and focuses of the plurality of liquid crystal layers 20. The liquid crystal layers 20 and the lens 10 may be used to constitute an eyeglass lens for correction of human vision. The multilayer liquid crystal lens 1 may concentrate a part of incident light by forming a plurality of liquid crystal layers 20 on a concave lens for myopia correction, to provide a second focus for hyperopia correction. That is, when a person with myopia develops hyperopia due to aging, the multilayer liquid crystal lens 1 may be used as a multifocal lens. Alternatively, the multilayer liquid crystal lens 1 may be used in telescopes, cameras, optical equipment, and various other applications.

The focal position of the multilayer liquid crystal lens 1 may vary depending on whether the lens 10 is a convex lens or a concave lens and whether the plurality of liquid crystal layers 20 is formed on the surface 10a or the opposite surface 10b. Based on light LT advancing from the opposite surface 10b toward the surface 10a, the manner in which the liquid crystal layer 20 formed on the surface 10a or the opposite surface 10b converges or diverges light may vary.

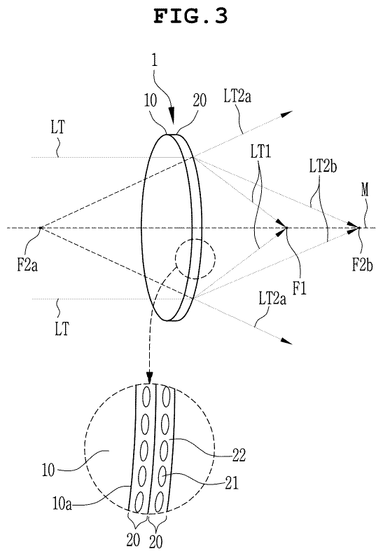

FIG. 3 is a view showing a multilayer liquid crystal lens 1 in which a liquid crystal layer 20 is formed on one surface 10a of a convex lens in accordance with an embodiment.

In the multilayer liquid crystal lens 1, a lens 10 is a convex lens, and a plurality of liquid crystal layers 20 is formed on the surface 10a. The liquid crystal layers 20 refract a part of light advancing from an opposite surface 10b of the lens 10 to the surface 10a of the lens 10, and may diverge the refracted light part, that is, light LT2a or LT2b, from a center M of the lens 10.

Light LT may advance from the opposite surface 10b of the lens 10 toward the surface 10a of the lens 10. The plurality of liquid crystal layers 20 may allow a part of the light LT, that is, light LT1, to pass therethrough without refraction. The unrefracted light LT1 may be converged to the center M due to the shape of the lens 10, which is a convex lens. The unrefracted light LT1 may form a first focus F1 that is a real focus formed at the side of the surface 10a of the lens 10.

The plurality of liquid crystal layers 20 may diverge the refracted light LT2a or LT2b from the center M in accordance with the shape of the surface 10a of the lens 10. Among the light LT advancing from the opposite surface 10b of the lens 10 toward the surface 10a of the lens 10, the light refracted by the plurality of liquid crystal layers 20, that is, the light LT2a or LT2b, may diverge from the center M in accordance with the shape of the liquid crystal layers 20. Since the plurality of liquid crystal layers 20 is formed on the surface 10a of the convex lens, the plurality of liquid crystal layers 20 may form a shape like a concave lens with respect to the light LT advancing from the opposite surface 10b to the surface 10a of the lens 10. Accordingly, the plurality of liquid crystal layers 20 may diverge the refracted light LT2a or LT2b from the center M of the lens 10.

The refracted light LT2a or LT2b is converged or diverged in accordance with the shape of the lens 10 and is also converged or diverged in accordance with the shape of the plurality of liquid crystal layers 20. Accordingly, the refracted light LT2a or LT2b may be ultimately converged or diverged in accordance with the sum of refractive power of the lens 10 and refractive power of the plurality of liquid crystal layers 20.

In accordance with a difference between the refractive power of the plurality of liquid crystal layers 20 and the refractive power of the lens 10, the final focal position formed by the refracted light LT2a or LT2b may vary. When the refractive power of the plurality of liquid crystal layers 20 is greater than that of the lens 10, the refracted light LT2a may be diverged to form a second focus F2a that is a virtual focus formed at the side of the opposite surface 10b of the lens 10.

When the refractive power of the plurality of liquid crystal layers 20 is less than that of the lens 10, the refracted light LT2b may be converged to form a second focus F2b that is a real focus formed at the side of the surface 10a of the lens 10. The second focus F2b, which is a real focus, may be formed at a position farther from the surface 10a than the first focus F1. This is because the plurality of liquid crystal layers 20 diverges the refracted light LT2b.

The degree of divergence of the refracted light LT2a or LT2b may be proportional to the number of liquid crystal layers 20. The degree of divergence of the refracted light LT2a or LT2b may be increased in the case in which the number of liquid crystal layers 20 is two, as compared to the case in which a single liquid crystal layer 20 is used. Within the liquid crystal layer 20, liquid crystals 21 may be aligned in a predetermined alignment direction. The alignment direction of the liquid crystals 21 in the plurality of liquid crystal layers 20 will be described later.

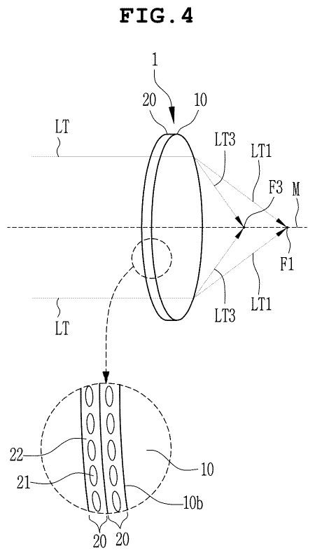

FIG. 4 is a view showing a multilayer liquid crystal lens 1 in which a liquid crystal layer 20 is formed on an opposite surface 10b of a convex lens in accordance with an embodiment.

In the multilayer liquid crystal lens 1, a lens 10 is a convex lens, and a plurality of liquid crystal layers 20 is formed on the opposite surface 10b of the lens 10. The plurality of liquid crystal layers 20 refracts a part of light advancing from the opposite surface 10b of the lens 10 to a surface 10a of the lens 10 and may converge the refracted light part toward a center M of the lens 10.

Light LT may advance from the opposite surface 10b of the lens 10 toward the surface 10a of the lens 10. The plurality of liquid crystal layers 20 may allow a part of the light LT, that is, light LT1, to pass therethrough without refraction. The unrefracted light LT1 may be converged to the center M in accordance with the shape of the convex lens 10. The unrefracted light LT1 may form a first focus F1 that is a real focus formed at the side of the surface 10a of the lens 10.

The plurality of liquid crystal layers 20 may refract a part of the light LT, that is, light LT3. The plurality of liquid crystal layers 20 may converge the refracted light LT3 toward the center M in accordance with the shape of the opposite surface 10b of the lens 10. Among the light LT advancing from the opposite surface 10b of the lens 10 toward the surface 10a of the lens 10, the light LT3 refracted by the plurality of liquid crystal layers 20 may be converged toward the center M in accordance with the shape of the liquid crystal layers 20. Since the plurality of liquid crystal layers 20 is formed on the opposite surface 10b of the convex lens, the plurality of liquid crystal layers 20 may form a shape like a convex lens with respect to light LT advancing from the opposite surface 10b of the lens 10 to the surface 10a of the lens 10. Accordingly, the plurality of liquid crystal layers 20 may converge the refracted light LT3 toward the center M of the lens 10. The refracted light LT3 may form a third focus F3 that is a real focus formed at the side of the surface 10a of the lens 10. Since both the convex lens and the plurality of liquid crystal layers 20 converge the refracted light LT3 toward the center M, the position at which the third focus F3 is formed may be closer to the surface 10a of the lens 10 than the position at which the first focus F1 is formed.

The degree of convergence of the refracted light may be proportional to the number of liquid crystal layers 20. The degree of convergence of the refracted light may be increased in the case in which the number of liquid crystal layers 20 is two, as compared to the case in which a single liquid crystal layer 20 is used. Within the liquid crystal layer 20, liquid crystals 21 may be aligned in a predetermined alignment direction. The alignment direction of the liquid crystals 21 in the plurality of liquid crystal layers 20 will be described later.

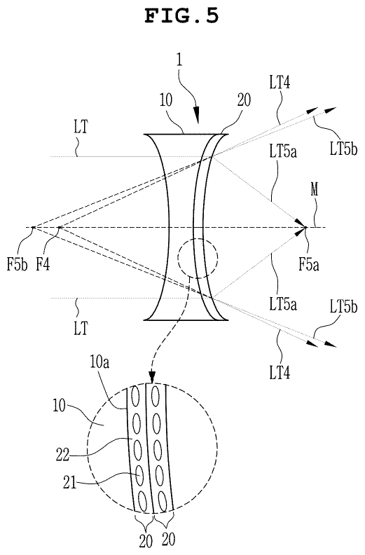

FIG. 5 is a view showing a multilayer liquid crystal lens 1 in which a liquid crystal layer 20 is formed on one surface 10a of a concave lens in accordance with an embodiment.

In the multilayer liquid crystal lens 1, a lens 10 is a concave lens, and a plurality of liquid crystal layers 20 is formed on the surface 10a. The plurality of liquid crystal layers 20 may refract a part of light LT advancing from an opposite surface 10b of the lens 10 to the surface 10a of the lens 10 and may converge the refracted light part, that is, light LT5a or Lt5b, Toward a Center M of the Lens 10.

Light LT may advance from the opposite surface 10b of the lens 10 toward the surface 10a of the lens 10. The plurality of liquid crystal layers 20 may allow a part of the light LT, that is, light LT4, to pass therethrough without refraction. The unrefracted light LT4 may diverge from the center M due to the shape of the concave lens 10. The unrefracted light LT4 may form a fourth focus F4 that is a virtual focus formed at the side of the opposite surface 10b of the lens 10.

The plurality of liquid crystal layers 20 may refract a part of the light, that is, light LT5a or LT5b. The plurality of liquid crystal layers 20 may converge the refracted light LT5a or LT5b toward the center M in accordance with the shape of the surface 10a of the lens 10. Among the light LT advancing from the opposite surface 10b of the lens 10 toward the surface 10a of the lens 10, the light refracted by the plurality of liquid crystal layers 20, that is, the refracted light LT5a or LT5b, may be converged toward the center M in accordance with the shape of the liquid crystal layer 20. Since the plurality of liquid crystal layers 20 is formed on the surface 10a of the concave lens, the plurality of liquid crystal layers 20 may form a shape like a convex lens with respect to the light LT advancing from the opposite surface 10b of the lens 10 to the surface 10a of the lens 10. Accordingly, the plurality of liquid crystal layers 20 may converge the refracted light LT5a or LT5b toward the center M of the lens 10.

The refracted light LT5a or LT5b is converged or diverged due to the shape of the lens 10 and is also converged or diverged due to the shape of the plurality of liquid crystal layers 20. Accordingly, the refracted light LT5a or LT5b may be ultimately converged or diverged in accordance with the sum of refractive power of the lens 10 and refractive power of the plurality of liquid crystal layers 20.

In accordance with a difference between the refractive power of the plurality of liquid crystal layers 20 and the refractive power of the lens 10, the final focal position formed by the refracted light LT5a or LT5b may vary. When the refractive power of the plurality of liquid crystal layers 20 is greater than that of the lens 10, the refracted light LT5a is converged to form a fifth focus F5a that is a real focus formed at the side of the surface 10a of the lens 10.

When the refractive power of the plurality of liquid crystal layers 20 is less than that of the lens 10, the refracted light LT5b may be diverged to form a fifth focus F5b that is a virtual focus formed at the side of the opposite surface 10b of the lens 10. The fifth focus F5b, which is a virtual focus, may be formed at a position farther from the opposite surface 10b than the fourth focus F4. This is because the plurality of liquid crystal layers 20 converges the refracted light LT5b.

The degree of convergence of the refracted light LT5a or LT5b may be proportional to the number of liquid crystal layers 20. The degree of convergence of the refracted light LT5a or LT5b may be increased in the case in which the number of liquid crystal layers 20 is two, as compared to the case in which a single liquid crystal layer 20 is used. Within the liquid crystal layer 20, liquid crystals 21 may be aligned in a predetermined alignment direction. The alignment direction of the liquid crystals 21 in the plurality of liquid crystal layers 20 will be described later.

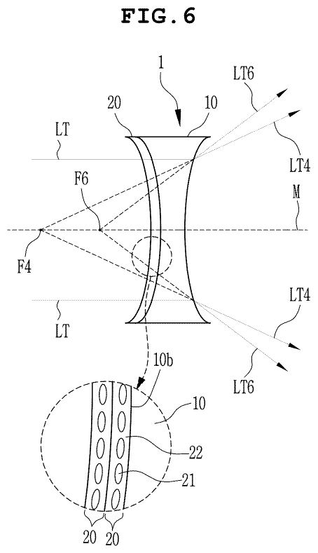

FIG. 6 is a view showing a multilayer liquid crystal lens 1 in which a liquid crystal layer 20 is formed on an opposite surface 10b of a concave lens in accordance with an embodiment.

In the multilayer liquid crystal lens 1, a lens 10 is a concave lens, and a plurality of liquid crystal layers 20 is formed on the opposite surface 10b of the lens 10. The plurality of liquid crystal layers 20 may refract a part of light advancing from the opposite surface 10b of the lens 10 to a surface 10a of the lens 10 and may diverge the refracted light part from a center M of the Lens 10.

Light LT may advance from the opposite surface 10b of the lens 10 toward the surface 10a of the lens 10. The plurality of liquid crystal layers 20 may allow a part of the light LT, that is, light LT4, to pass therethrough without refraction. The unrefracted light LT4 may be diverged from the center M due to the shape of the lens 10 which is a concave lens. The unrefracted light LT4 may form a fourth focus F4 that is a virtual focus formed at the side of the opposite surface 10b of the lens 10.

The plurality of liquid crystal layers 20 may refract a part of the light LT, that is, light LT6. The plurality of liquid crystal layers 20 may diverge the refracted light LT6 from the center M in accordance with the shape of the surface 10a of the lens 10. Among the light LT advancing from the opposite surface 10b of the lens 10 toward the surface 10a of the lens 10, the light refracted by the plurality of liquid crystal layers 20, that is, the light LT6, may be diverged from the center M in accordance with the shape of the liquid crystal layers 20. Since the plurality of liquid crystal layers 20 is formed on the opposite surface 10b of the concave lens, the plurality of liquid crystal layers 20 may form a shape like a concave lens with respect to the light LT advancing from the opposite surface 10b of the lens 10 to the surface 10a of the lens 10. Accordingly, the plurality of liquid crystal layers 20 may diverge the refracted light LT6 from the center M of the lens 10. The refracted light LT6 may be converged to form a sixth focus F6 that is a virtual focus formed at the side of the opposite surface 10b of the lens 10. Since both the concave lens and the plurality of liquid crystal layers 20 diverge the refracted light LT6 from the center M, the position at which the sixth focus F6 is formed may be closer to the opposite surface 10b of the lens 10 than the position at which the fourth focus F4 is formed.

The degree of divergence of the refracted light may be proportional to the number of liquid crystal layers 20. The degree of divergence of the refracted light may be increased in the case in which the number of liquid crystal layers 20 is two, as compared to the case in which a single liquid crystal layer 20 is used. Within the liquid crystal layer 20, liquid crystals 21 may be aligned in a predetermined alignment direction. The alignment direction of the liquid crystals 21 in the plurality of liquid crystal layers 20 will be described later.

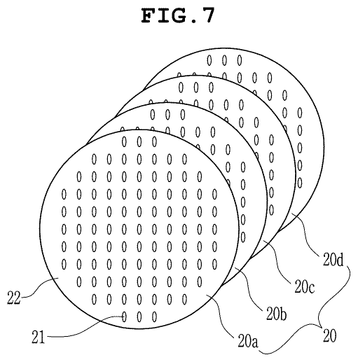

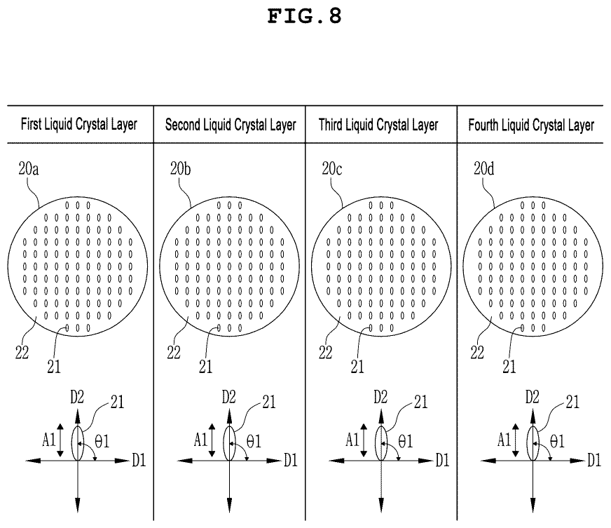

FIG. 7 is a view showing a plurality of liquid crystal layers 20 having the same alignment direction of liquid crystals 21 in accordance with an embodiment. FIG. 8 is a view showing respective alignment directions of liquid crystals 21 in the plurality of liquid crystal layers 20 of FIG. 6. FIG. 9 is a diagram showing a variation in focal length according to the number of liquid crystal layers 20 having the same alignment direction of liquid crystals 21 in accordance with an embodiment.

A plurality of liquid crystal layers 20 may be formed by stacking two or more liquid crystal layers 20 in a predetermined direction. The refractive power may be proportional to the number of liquid crystal layers 20. Since each liquid crystal layer 20 is a thin layer, such a thin liquid crystal layer 20 may have limited refractive power to converge or diverge light. As a plurality of liquid crystal layers 20 is stacked, each liquid crystal layer 20 may converge or diverge light. That is, the refractive power of the plurality of liquid crystal layers 20 may be the sum of refractive powers of respective liquid crystal layers 20.

In the plurality of liquid crystal layers 20, alignment directions of liquid crystals 21 in respective liquid crystal layers 20 may be identical. For example, as shown in FIG. 7, alignment directions of liquid crystals 21 in four liquid crystal layers 20a, 20b, 20c, and 20d may be identical. The first to fourth liquid crystal layers 20a to 20d each include a plurality of liquid crystals 21. The liquid crystals 21 in each liquid crystal layer 20 are aligned in a vertical direction in the drawing, and alignment directions of the liquid crystals 21 in the first to fourth liquid crystal layers 20a to 20d are identical.

This may be explained with respect to two directions D1 and D2 forming a plane of the liquid crystal layer 20. As shown in FIG. 8, an alignment direction A1 of liquid crystals 21 in the first to fourth liquid crystal layers 20a to 20d corresponds to the direction D2. That is, alignment directions of liquid crystals 21 in a plurality of liquid crystal layers 20 may be identical.

In this structure, light refracted by liquid crystals 21 when passing through the first liquid crystal layer 20a may be again refracted when passing through the second liquid crystal layer 20b. Additionally, the refracted light may be repeatedly refracted when passing through the third liquid crystal layer 20c and then passing through the fourth liquid crystal layer 20d. As the light passes through respective liquid crystal layers 20, degrees of convergence to or divergence from the center of the lens 10 depending on the shape of the liquid crystal layers 20 (i.e., the shape of one surface 10a or an opposite surface 10b of the lens 10 on which the liquid crystal layers 20 are formed) may be cumulatively summed.

For example, as shown in FIG. 9, a focal length may vary depending on the number of liquid crystal layers 20 formed on an opposite surface 10b of a convex lens. When there is only one liquid crystal layer 20, there are a seventh focus F7 formed by light not refracted by the liquid crystal layer 20 and an eighth focus F8 formed by light refracted by the liquid crystal layer 20. In this case, the position of the eighth focus F8 does not significantly differ from that of the seventh focus F7.

When there are two liquid crystal layers 20, a ninth focus F9 formed by light refracted by the liquid crystal layers 20 may be positioned closer to one surface 10a of the lens 10 than the eighth focus F8. This is because the light forming the ninth focus F9 is converged by the two liquid crystal layers 20. Similarly, when there are three liquid crystal layers 20, a tenth focus F10 may be formed closer to the lens 10 than the ninth focus F9, and when there are four liquid crystal layers 20, an eleventh focus F11 may be formed closer to the lens 10 than the tenth focus F10.

In such a manner, increasing the number of liquid crystal layers 20 may enhance the overall refractive power of the multiple liquid crystal layers 20. Accordingly, a multilayer liquid crystal lens 1 having desired refractive power may be designed. In any cases in which a plurality of liquid crystal layers 20 is formed on one surface 10a of a convex lens 10 or one surface 10a or an opposite surface 10b of a concave lens 10, refractive power may be increased in the same manner.

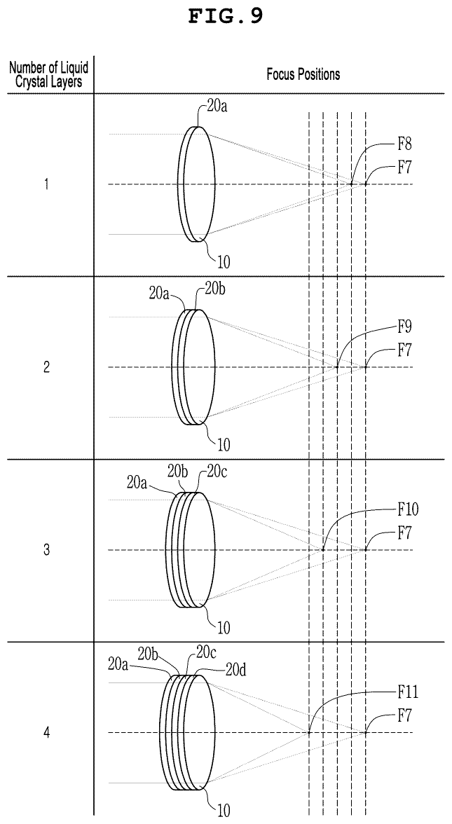

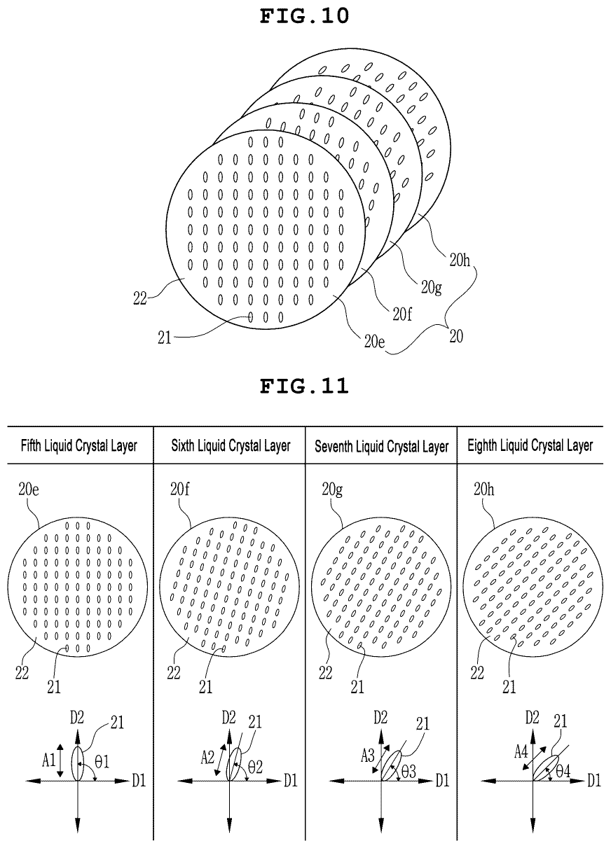

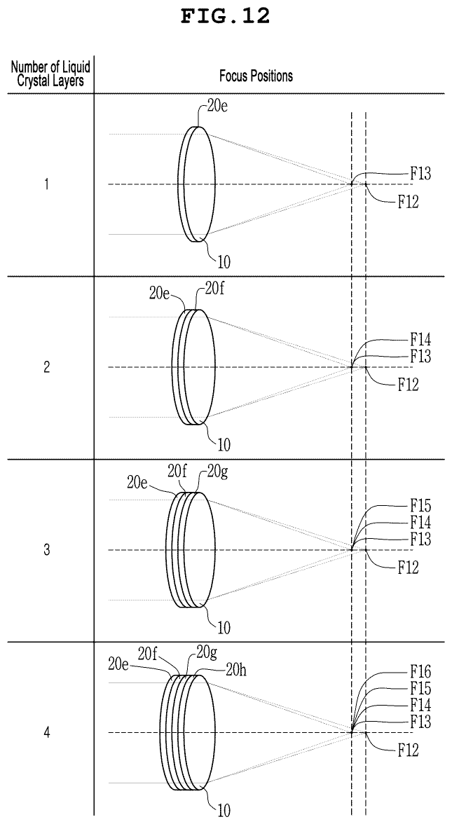

FIG. 10 is a view showing a plurality of liquid crystal layers 20 having different alignment directions of liquid crystals 21 in accordance with an embodiment. FIG. 11 is a diagram showing alignment directions of liquid crystals 21 in respective liquid crystal layers 20 of FIG. 10. FIG. 12 is a diagram showing focuses of the plurality of liquid crystal layers 20 having different alignment directions of liquid crystals 21 in accordance with the embodiment.

Each of the plurality of liquid crystal layers 20 may have an alignment direction of liquid crystals 21 rotated unidirectionally about a center of the lens 10, and rotation angles of the liquid crystals 21 in respective liquid crystal layers 20 may be different. For example, as shown in FIG. 10, alignment directions of the liquid crystals 21 in four liquid crystal layers 20e, 20f, 20g, and 20h may be different. The fifth to eighth liquid crystal layers 20e to 20h may each include a plurality of liquid crystals 21, and the alignment direction of the liquid crystals 21 in each liquid crystal layer 20 may be rotated unidirectionally about the center of the lens 10.

This may be explained with respect to two directions D1 and D2 forming a plane of the liquid crystal layer 20. As shown in FIG. 11, an alignment direction A1 of liquid crystals 21 in a fifth liquid crystal layer 20e corresponds to the direction D2. That is, the alignment direction A1 of liquid crystals 21 in the fifth liquid crystal layer 20e may form a first angle θ1 with respect to the direction D1. A sixth liquid crystal layer 20f may have an alignment direction A2 slightly rotated in a clockwise direction from the alignment direction A1. That is, the alignment direction A2 of the liquid crystals 21 in the sixth liquid crystal layer 20f may form a second angle θ2 with respect to the direction D1. A seventh liquid crystal layer 20g may have an alignment direction A3 of liquid crystals 21 further rotated in the clockwise direction than the alignment direction A2 of the liquid crystals 21 in the sixth liquid crystal layer 20f. That is, the alignment direction A3 of the liquid crystals 21 in the seventh liquid crystal layer 20g may form a third angle θ3 with respect to the direction D1. The third angle θ3 may be less than the second angle θ2. An eighth liquid crystal layer 20h may have an alignment direction A4 of liquid crystals 21 further rotated in the clockwise direction than the alignment direction A3 of the liquid crystals 21 in the seventh liquid crystal layer 20g. That is, the alignment direction A4 of the liquid crystals 21 in the eighth liquid crystal layer 20h may form a fourth angle θ4 with respect to the direction D1. The fourth angle θ4 may be less than the third angle θ3. Rotation of the alignment direction of the liquid crystals 21 may also be carried out in a counterclockwise direction.

In such a structure, when there is only one liquid crystal layer 20, there may be two focuses. One of the two focuses is formed by the lens 10, and the other of the two focuses is formed by the single liquid crystal layer 20. Light not refracted by the liquid crystals 21 when passing through the fifth liquid crystal layer 20e may form a twelfth focus F12 due to the lens 10. Light refracted by the liquid crystals 21 when passing through the fifth liquid crystal layer 20e may form a thirteenth focus F13.

When there are two liquid crystal layers 20, there may be three focuses. One of the three focuses is formed by the lens 10, and the remaining two of the three focuses are formed by the two liquid crystal layers 20. Light not refracted by the liquid crystals 21 when passing through the fifth liquid crystal layer 20e may form the twelfth focus F12 due to the lens 10. Light refracted by the liquid crystals 21 passing through the fifth liquid crystal layer 20e may form the thirteenth focus F13. Additionally, the light refracted by the liquid crystals 21 when passing through the fifth liquid crystal layer 20e may not be refracted when passing through the sixth liquid crystal layer 20f. This is because the alignment direction of the liquid crystals 21 in the sixth liquid crystal layer 20f is different from that in the fifth liquid crystal layer 20e. Similarly, during the process in which light passes through the lens 10 and the fifth liquid crystal layer 20e, a part of the light not refracted by the liquid crystals 21 may be refracted by the sixth liquid crystal layer 20f to form a fourteenth focus F14. In this case, the fourteenth focus F14 may be formed at the same position as the thirteenth focus F13 because the fourteenth focus F14 is formed by one liquid crystal layer. Of course, in this case, the light intensity at a point where the thirteenth focus F13 and the fourteenth focus F14 are positioned may be further increased. This is because both the light refracted by the fifth liquid crystal layer 20e and the light refracted by the sixth liquid crystal layer 20f are converged at a single focus. That is, the light intensity at the point where the thirteenth focus F13 and the fourteenth focus F14 coincide may be twice the light intensity at a focus formed by a single liquid crystal layer.

Similarly, when there are three liquid crystal layers 20, there may be four focuses (the twelfth focus F12 to a fifteenth focus F15). The thirteenth focus F13, the fourteenth focus F14, and the fifteenth focus F15 may be formed at the same position. This is because a part of the light not refracted by the fifth liquid crystal layer 20e and the sixth liquid crystal layer 20f is refracted by a seventh liquid crystal layer 20g to form the fifteenth focus F15. Additionally, the light intensity at the point where the three focuses F13, F14, and F15 coincide may be three times the light intensity at a focus formed by a single liquid crystal layer.

Similarly, when there are four liquid crystal layers 20, there may be five focuses (the twelfth focus F12 to a sixteenth focus F16). The thirteenth focus F13, the fourteenth focus F14, the fifteenth focus F15, and the sixteenth focus F16 may be formed at the same position. This is because a part of the light not refracted by the fifth liquid crystal layer 20e, the sixth liquid crystal layer 20f, and the seventh liquid crystal layer 20g is refracted by an eighth liquid crystal layer 20h to form the sixteenth focus F16. Additionally, the light intensity at the point where the four focuses F13, F14, F15, and F16 coincide may be four times the light intensity at a focus formed by a single liquid crystal layer.

By increasing the number of liquid crystal layers 20 in the above-described manner, it may be possible to obtain a multilayer liquid crystal lens 1 configured to converge, at a specific focus, light of an increased intensity proportional to the increased number of liquid crystal layers. Since the quantity of light converged in accordance with alignment of liquid crystals is adjustable, the multilayer liquid crystal lens 1 may be utilized in a variety of optical devices.

The plurality of liquid crystal layers 20 may have respective rotation angles sequentially increased from one another by approximately the same incremental angle. The fifth to eighth liquid crystal layers 20e to 20h shown in FIG. 11 may have respective alignment directions of liquid crystals 21 sequentially rotated at intervals of about 15 degrees. For example, the alignment direction A1 of the liquid crystals 21 in the fifth liquid crystal layer 20e may be at 90 degrees with reference to the direction D1, the alignment direction A2 in the sixth liquid crystal layer 20f may be at 75 degrees with reference to the direction D1, the alignment direction A3 in the seventh liquid crystal layer 20g may be at 60 degrees with reference to the direction D1, and the alignment direction A4 in the eighth liquid crystal layer 20h may be at 45 degrees with reference to the direction D1. In this manner, the plurality of liquid crystal layers 20 may be sequentially rotated at intervals of a predetermined angle. In other words, rotation angle differences between adjacent liquid crystal layers may be equal. For example, the angle difference between the alignment direction A1 in the fifth liquid crystal layer 20e and the alignment direction A2 in the sixth liquid crystal layer 20f may be 15 degrees, and the angle difference between the alignment direction A2 in the sixth liquid crystal layer 20f and the alignment direction A3 in the seventh liquid crystal layer 20g may be 15 degrees. With reference to the fifth liquid crystal layer 20e, the sixth liquid crystal layer 20f may be in a state of being rotated by 15 degrees, the seventh liquid crystal layer 20g may be in a state of being rotated by 30 degrees, and the eighth liquid crystal layer 20h may be in a state of being rotated by 45 degrees. Thus, the rotation angles of the liquid crystal layers 20 may sequentially increase by the same incremental angle.

Alternatively, the rotation angles of the plurality of liquid crystal layers 20 may sequentially increase by sequentially-increased incremental angles. For example, differently from the case of FIG. 11, with reference to the fifth liquid crystal layer 20e, the sixth liquid crystal layer 20f may be in a state of being rotated by 10 degrees, the seventh liquid crystal layer 20g may be in a state of being rotated by 30 degrees, and the eighth liquid crystal layer 20h may be in a state of being rotated by 60 degrees.

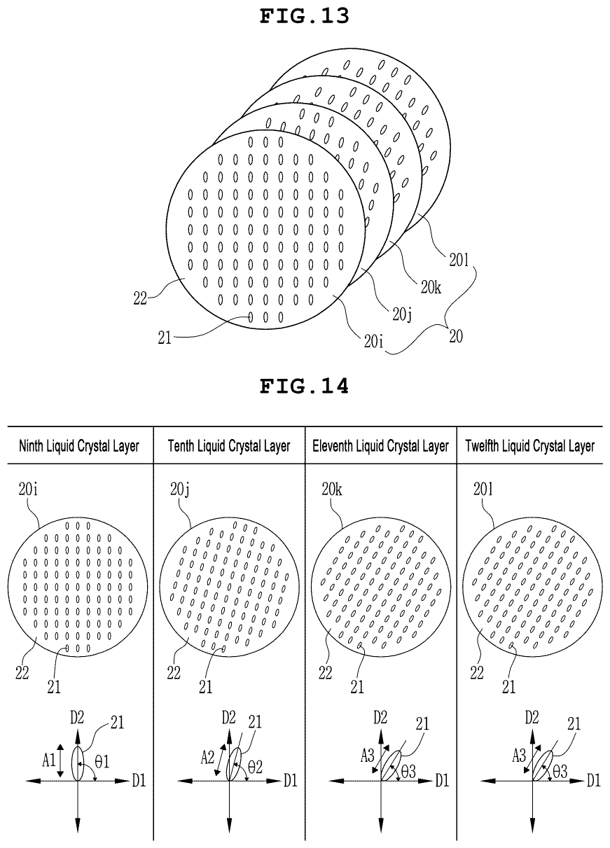

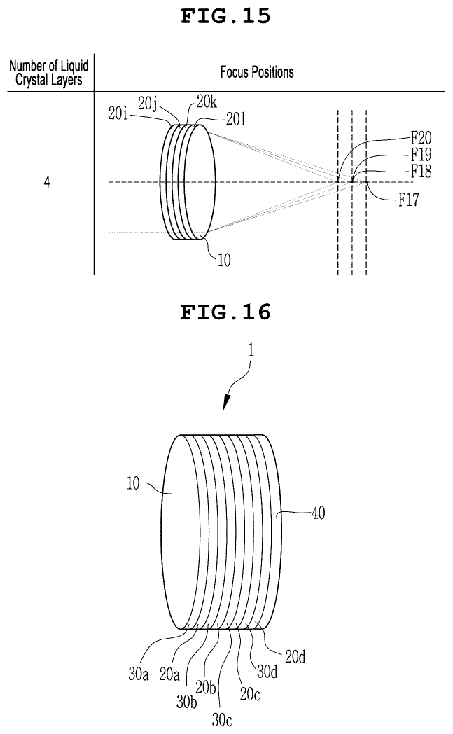

FIG. 13 is a view showing a plurality of liquid crystal layers 20 having the same alignment direction of liquid crystals 21 and a plurality of liquid crystal layers 20 having different alignment directions of liquid crystals 21 in accordance with an embodiment. FIG. 14 is a diagram showing alignment directions of liquid crystals 21 in the plurality of liquid crystal layers of FIG. 13. FIG. 15 is a diagram showing focuses according to the plurality of liquid crystal layers 20 having different alignment directions of liquid crystals 21 and focuses according to the plurality of liquid crystal layers 20 having the same alignment direction of liquid crystals 21 in the shown embodiment.

A plurality of liquid crystal layers 20 may include a plurality of liquid crystal layers 20k and 20l having the same alignment direction of liquid crystals 21 and a plurality of liquid crystal layers 20i, 20j, and 20k having different alignment directions of liquid crystals 21. A part of the plurality of liquid crystal layers 20 may have different alignment directions of liquid crystals 21, whereas another part of the plurality of liquid crystal layers may have the same alignment direction of liquid crystals 21. For example, as shown in FIG. 13, among four liquid crystal layers 20i, 20j, 20k, and 20l, alignment directions of liquid crystals 21 in the ninth liquid crystal layer 20i, the tenth liquid crystal layer 20j, and the eleventh liquid crystal layer 20k may be different, and alignment directions of liquid crystals 21 in the eleventh liquid crystal layer 20k and the twelfth liquid crystal layer 20l may be the same.

This may be explained with respect to two directions D1 and D2 forming a plane of the liquid crystal layer 20. As shown in FIG. 14, the ninth liquid crystal layer 20i may have an alignment direction A1 of liquid crystals 21 corresponding to the direction D2. That is, the alignment direction A1 of liquid crystals 21 in the ninth liquid crystal layer 20i may form a first angle θ1 with respect to the direction D1. The tenth liquid crystal layer 20j may have an alignment direction A2 of liquid crystals 21 rotated in a clockwise direction by a predetermined angle. That is, the alignment direction A2 of liquid crystals 21 in the tenth liquid crystal layer 20j may form a second angle θ2 with respect to the direction D1. The eleventh liquid crystal layer 20k may have an alignment direction A3 of liquid crystals 21 further rotated in the clockwise direction than the alignment direction A2 of the tenth liquid crystal layer 20j. That is, the alignment direction A3 of liquid crystals 21 in the eleventh liquid crystal layer 20k may form a third angle θ3 with respect to the direction D1. The third angle θ3 may be less than the second angle θ2. The twelfth liquid crystal layer 20l may have an alignment direction of liquid crystals identical to the alignment direction A3 of liquid crystals 21 in the eleventh liquid crystal layer 20k.

Referring to FIG. 15, in this structure, the multilayer liquid crystal lens 1 formed with the four liquid crystal layers 20i, 20j, 20k, and 20l may have four focuses. The four focuses may be a seventeenth focus F17 formed by the lens 10, an eighteenth focus F18 formed by the ninth liquid crystal layer 20i, a nineteenth focus F19 formed by the tenth liquid crystal layer 20j, and a twentieth focus F20 formed by the eleventh and twelfth liquid crystal layers 20k and 20l.

The seventeenth focus F17 may be formed by light not refracted by the four liquid crystal layers. Accordingly, the seventeenth focus F17 may be positioned at a point farthest from the lens 10.

Since the ninth liquid crystal layer 20i and the tenth liquid crystal layer 20j have different alignment directions of liquid crystals 21, the ninth liquid crystal layer 20i and the tenth liquid crystal layer 20j may refract a part of light to form the eighteenth focus F18 and the nineteenth focus F19, respectively. The eighteenth focus F18 and the nineteenth focus F19 may be formed at the same position. Since the refractive power of each of the eighteenth focus F18 and the nineteenth focus F19 corresponds to the sum of the refractive power of the lens 10 and the refractive power of one liquid crystal layer, the eighteenth focus F18 and the nineteenth focus F19 may be positioned closer to the lens 10 than the seventeenth focus F17. The light intensity at the position where the eighteenth focus F18 and the nineteenth focus F19 are positioned may be twice the light intensity at a focus formed by one liquid crystal layer 20.

Since the eleventh liquid crystal layer 20k and the twelfth liquid crystal layer 20l have the same alignment of liquid crystals 21 and light refracted by the eleventh layer 20k is again refracted by the twelfth layer 20l, the position of the twentieth focus F20 may be closer to the lens 10 than the point where the eighteenth focus F18 and the nineteenth focus F19 are formed. However, the light intensity at the point where the twentieth focus F20 is formed is equal to the light intensity at the focus formed by one liquid crystal layer 20. This is because the eleventh liquid crystal layer 20k and the twelfth liquid crystal layer 20l, which have the same alignment direction of liquid crystals 21, refract only light traveling in one direction.

It may be possible to obtain a multilayer liquid crystal lens 1 formed with a plurality of focuses by determining the number of liquid crystal layers 20 having the alignment direction A1 of liquid crystals 21 and the number of liquid crystal layers 20 having the alignment direction A2 of liquid crystals 21 to be different from each other in the above-described manner. The multilayer liquid crystal lens 1 may vary a focal distance and light intensity in accordance with the alignment direction of liquid crystals 21 and the number of liquid crystal layers 20 and, as such, may be used in various optical devices, such as spectrometers, etc.

FIG. 16 is a view showing a multilayer liquid crystal lens 1 further including a plurality of alignment layers 30 and a protective layer 40 in accordance with an embodiment.

The multilayer liquid crystal lens 1 may further include a plurality of alignment layers 30 configured to align liquid crystals 21 in predetermined directions for a plurality of liquid crystal layers 20, respectively. The alignment layer 30 may align liquid crystals 21 included in the liquid crystal layer 20 in a predetermined direction. The alignment layer 30 may have grooves formed at fine intervals or a compound arranged at predetermined intervals and configured to fix liquid crystals 21. When the liquid crystals 21 come into contact with the alignment layer 30, the liquid crystals 21 may be aligned in a direction guided by the alignment layer 30.

When the liquid crystals 21 are suspended in a fluid, the liquid crystals 21 may be disposed in a random arrangement. In this case, refraction may occur for random polarization components. To refract light of a specified polarization component, the liquid crystal layer 20 needs to maintain the liquid crystals 21 in a predetermined alignment direction. The multilayer liquid crystal lens 1 may fix the liquid crystals 21 in the predetermined alignment direction by using the alignment layer 30.

The alignment layer 30 may be formed by applying a material configured to determine an orientation of the lens 10 onto one surface 10a or an opposite surface 10b of the lens 10, through spin coating or a similar method. The alignment layer 30 may also be formed by applying a material configured to determine an orientation of the lens 10 onto a base film. The alignment layer 30 may be laminated on the liquid crystal layer 20 to fix the alignment of liquid crystals 21 of another liquid crystal layer 20 to be subsequently laminated.

A plurality of liquid crystal layers 20 and a plurality of alignment layers 30 may be alternately laminated. For example, a first alignment layer 30a may be formed on one surface 10a or the opposite surface 10b of the lens 10, and a first liquid crystal layer 20a may be formed on the first alignment layer 30a. A second alignment layer 30b may be formed on the first liquid crystal layer 20a, and a second liquid crystal layer 20b may be formed on the second alignment layer 30b. Similarly, a third alignment layer 30c may be formed on the second liquid crystal layer 20b, and a third liquid crystal layer 20c may be formed on the third alignment layer 30c. A fourth alignment layer 30d may be formed on the third liquid crystal layer 20c, and a fourth liquid crystal layer 20d may be formed on the fourth alignment layer 30d. The alignment layers 30 and the liquid crystal layers 20 may be alternately laminated.

The multilayer liquid crystal lens 1 may further include a protective layer 40 coupled to the plurality of liquid crystal layers 20. The protective layer 40 may be formed to cover the plurality of liquid crystal layers 20. The plurality of liquid crystal layers 20 may be disposed between the lens 10 and the protective layer 40. The protective layer 40 may be made of the same material as the lens 10 or may be formed of a synthetic resin film, glass, etc.

The protective layer 40 may protect the liquid crystal layer 20 from damage. When the multilayer liquid crystal lens 1 is applied to eyeglasses, impact may occur during use of the eyeglasses. Therefore, when the liquid crystal layer 20 is directly exposed to the outside, cracks may occur due to impact or the alignment of the liquid crystals 21 may be disturbed due to impact. The protective layer 40 may prevent the liquid crystal layer 20 from being directly damaged. The multilayer liquid crystal lens 1 further including the protective layer 40 may be more practically useful in daily life.

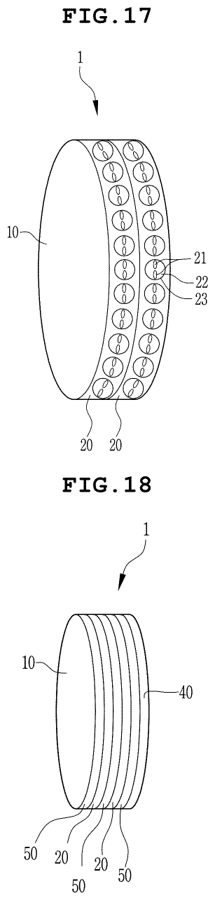

FIG. 17 is a view showing a plurality of liquid crystal layers 20 including capsules 23 according to an embodiment.

The liquid crystal layer 20 may further include a plurality of capsules 23 each configured to contain liquid crystals 21 and a binder 22 therein. Each of the plurality of liquid crystal layers 20 may include a plurality of capsules 23. Each of the capsules 23 may contain the liquid crystals 21 and the binder 22 therein.

Each capsule 23 may have a micrometer-scale size. The plurality of capsules 23 may be formed as a layer on one surface 10a or the opposite surface 10b of the lens 10, or on another liquid crystal layer 20. The plurality of capsules 23 may be formed as a single layer or as multiple layers. The single layer means that the capsules 23 are disposed without overlapping one another and fill the liquid crystal layer 20 without forming a gap. The multiple layers may be formed by laminating the single layer multiple times. A layer may also be formed as a thick layer in which capsules 23 are disposed in multiple layers within a single layer. When a process of manufacturing the liquid crystal layer 20 is performed under the condition that the liquid crystals 21 and the binder 22 are injected into the capsules 23, the liquid crystals 21 may be handled on a capsule basis. When capsules 23 of a uniform size are applied as a single layer, it may be possible to enable the liquid crystals 21 to be uniformly arranged within the liquid crystal layer 20, thereby achieving optical uniformity. The liquid crystal layer 20 may further include the capsules 23 and an additional binder 22 configured to fix the capsules 23. The additional binder 22 may also be a material curable by ultraviolet light or the like.

The plurality of liquid crystals 21 included in the plurality of capsules 23 may be aligned overall in a predetermined direction. As shown in FIG. 17, the long axis of the liquid crystals 21 in each capsule 23 may be aligned in parallel to a plane direction of the liquid crystal layer 20. The liquid crystals 21 in the capsules 23 included in each of the plurality of liquid crystal layers 20 may be aligned in the same direction, as shown in FIG. 8. Alternatively, as shown in FIG. 11, the liquid crystals 21 in the capsules 23 included in the plurality of liquid crystal layers 20 may be aligned in different directions rotated unidirectionally.

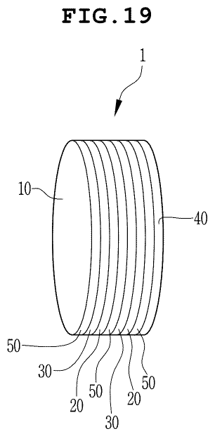

FIG. 18 is a view showing a multilayer liquid crystal lens 1 further including an adhesive layer 50 in accordance with an embodiment.

The multilayer liquid crystal lens 1 may further include an adhesive layer 50 configured to bond a liquid crystal layer 20 to the lens 10 or to another liquid crystal layer 20. The liquid crystal layer 20 may be fabricated as a film and may then be bonded onto the lens 10 or another liquid crystal layer 20. The adhesive layer 50 may be formed between the lens 10 and the liquid crystal layer 20 or between the liquid crystal layers 20, to couple a plurality of liquid crystal layers 20. The adhesive layer 50 may include an adhesive, an adhesive film, or the like. The adhesive layer 50 may be formed between the protective layer 40 and the liquid crystal layer 20 to allow the protective layer 40 to be bonded to the liquid crystal layer 20.

FIG. 19 is a view showing a multilayer liquid crystal lens 1 further including an alignment layer 30, a protective layer 40, and an adhesive layer 50 in accordance with an embodiment.

The adhesive layer 50 may be formed between the lens 10 and the alignment layer 30 and between the liquid crystal layer 20 and the alignment layer 30. However, an adhesive layer 50 is not formed between liquid crystal layers 20 in which liquid crystals 21 are aligned by the alignment layer 30. When there is a plurality of layers each including an alignment layer 30 and a liquid crystal layer 20 bonded to each other, an adhesive layer 50 may be formed among the plurality of layers.

In accordance with an embodiment of the present disclosure, it may be possible to provide a multilayer liquid crystal lens with refractive power enhanced using a plurality of liquid crystal layers.

The present disclosure has been described in detail through specific embodiments. The above description is only an example applying the principles of the present disclosure, and other configurations may be included within the scope of the present disclosure.

What is claimed is:

1. A multilayer liquid crystal lens comprising:
a lens having one surface and another surface opposite to the one surface; and
a plurality of liquid crystal layers formed on the one surface or the opposite surface of the lens,
wherein the plurality of liquid crystal layers refracts a part of light advancing from the opposite surface to the one surface in accordance with an alignment direction of liquid crystals in the plurality of liquid crystal layers and converges the refracted light part toward a center of the lens or diverges the refracted light part from the center in accordance with a convex or concave shape of the one surface or the opposite surface of the lens.

2. The multilayer liquid crystal lens according to claim 1, wherein:
the lens is a convex lens; and
the plurality of liquid crystal layers is formed on the one surface of the lens to refract a part of the light advancing from the opposite surface to the one surface and to diverge the refracted light part from the center.

3. The multilayer liquid crystal lens according to claim 1, wherein:
the lens is a convex lens; and
the plurality of liquid crystal layers is formed on the opposite surface of the lens to refract a part of the light advancing from the opposite surface to the one surface and to converge the refracted light part toward the center.

4. The multilayer liquid crystal lens according to claim 1, wherein:
the lens is a concave lens; and
the plurality of liquid crystal layers is formed on the one surface to refract a part of the light advancing from the opposite surface to the one surface and to converge the refracted light part toward the center.

5. The multilayer liquid crystal lens according to claim 1, wherein:
the lens is a concave lens; and
the plurality of liquid crystal layers is formed on the opposite surface to refract a part of the light advancing from the opposite surface to the one surface and to diverge the refracted light part from the center.

6. The multilayer liquid crystal lens according to claim 1, wherein the plurality of liquid crystal layers is formed by stacking two or more liquid crystal layers in a predetermined direction.

7. The multilayer liquid crystal lens according to claim 1, wherein, in the plurality of liquid crystal layers, alignment directions of liquid crystals in respective liquid crystal layers are identical.

8. The multilayer liquid crystal lens according to claim 1, wherein each of the plurality of liquid crystal layers has an alignment direction of liquid crystals rotated unidirectionally about the center of the lens, and rotation angles of the liquid crystals in respective liquid crystal layers are different.

9. The multilayer liquid crystal lens according to claim 1, wherein the plurality of liquid crystal layers comprises a plurality of liquid crystal layers having a same alignment direction of liquid crystals and a plurality of liquid crystal layers respectively having different alignment directions of liquid crystals.

10. The multilayer liquid crystal lens according to claim 1, further comprising:
a plurality of alignment layers configured to align liquid crystals in predetermined directions for the plurality of liquid crystal layers, respectively.

11. The multilayer liquid crystal lens according to claim 10, wherein the plurality of liquid crystal layers and the plurality of alignment layers are alternately laminated.

12. The multilayer liquid crystal lens according to claim 1, further comprising:
a protective layer coupled to the plurality of liquid crystal layers.

13. The multilayer liquid crystal lens according to claim 1, wherein each of the liquid crystal layers comprises:
liquid crystals configured to refract a part of light in accordance with an alignment direction thereof; and
a binder configured to fix the liquid crystals in the predetermined alignment direction.

14. The multilayer liquid crystal lens according to claim 13, wherein the liquid crystal layer further comprises:
a plurality of capsules configured to contain the liquid crystals and the binder therein.

15. The multilayer liquid crystal lens according to claim 14, wherein the plurality of capsules is formed as a layer on the one surface of the lens.

16. The multilayer liquid crystal lens according to claim 1, further comprising;
an adhesive layer configured to bond one of the liquid crystal layers to the lens or another one of the liquid crystal layers.
